(19) United States
(12) Patent Application Publication
(10) Pub. No.: US 2026/0164144 A1
(43) Pub. Date: Jun. 11, 2026

(54) SIGNAL PROCESSOR, PHOTOELECTRIC CONVERSION APPARATUS, AND EQUIPMENT

(71) Applicant: CANON KABUSHIKI KAISHA, Tokyo (JP)

(72) Inventors: HIROAKI TANIGUCHI, Tokyo (JP); NORIYUKI SHIKINA, Tokyo (JP); KEISUKE TAKAHASHI, Tokyo (JP); MOMONOSUKE ODANI, Kanagawa (JP); TOMOYA KOKADO, Kanagawa (JP)

(21) Appl. No.: 19/179,031

(22) Filed: Apr. 15, 2025

(30) Foreign Application Priority Data
Apr. 25, 2024 (JP) 2024-071637

(51) Int. Cl. H04N 25/628; H04N 25/625; H04N 25/779

(52) U.S. Cl. CPC H04N 25/628; H04N 25/625; H04N 25/779

(57) ABSTRACT

A signal processor corrects image data based on signals from a plurality of light receiving pixels by using light shielded data based on signals from a plurality of light shielded pixels. The signal processor comprises a line memory, a detection unit, a correction value generation unit, and a data correction unit. The line memory holds image data on a selected row, the detection unit generates a selection signal that selects a correction factor based on the image data on at least the selected row, the correction value generation unit generates and holds a correction value based on the correction factor selected by the selection signal and light shielded data on the selected row, and the data correction unit corrects image data on the selected row held in the line memory based on the correction value.

### BACKGROUND OF THE INVENTION

### Field of the Invention

One disclosure aspect of the embodiments relates to a signal processor, a photoelectric conversion apparatus, and equipment.

### Description of the Related Art

There is available a method that is provided with a light receiving region including a plurality of pixels and a light shielded region (which can also be called an optical black (OB) region) which is provided around the light receiving region and shielded against light and is configured to perform black level correction based on data from the light shielded region. Japanese Paten Laid-Open No. 2016-119592 (herein after PTL 1) discloses an apparatus that corrects streaking (to be also referred to as “horizontal smear”) that has occurred on the right and left sides of a high-luminance object image when the high-luminance object is imaged.

PTL 1 discloses an apparatus that detects the occurrence of streaking from the data of light shielded pixels on the same row as light receiving pixels when a high-luminance object is located in a light receiving region and performs streaking correction based on the offset values detected from the right and left sides of the high-luminance object image. According to PTL 1, if random noise and the like are included in the signals obtained from pixels in an optical black region, the detection accuracy of streaking can decrease. In addition, correction has sometimes caused horizontal stripes in a region where streaking has occurred.

### SUMMARY OF THE INVENTION

One disclosed embodiment has been made in consideration of the above-described disadvantages, and provides an arrangement advantageous in improving the detection accuracy of horizontal smear and suppressing the occurrence of horizontal stripes at the time of horizontal smear correction.

According to one aspect of present invention, there is provided a signal processor that corrects image data based on signals from a plurality of light receiving pixels by using light shielded data based on signals from a plurality of light shielded pixels. The signal processor comprises a line memory, a detection unit, a correction value generation unit, and a data correction unit. The line memory holds image data on a selected row, the detection unit generates a selection signal that selects a correction factor based on the image data on at least the selected row, the correction value generation unit includes a correction value holding unit configured to hold a correction value and generates and holds the correction value based on the correction factor selected by the selection signal and light shielded data on the selected row, and the data correction unit corrects image data on the selected row held in the line memory based on the correction value.

### BRIEF DESCRIPTION OF THE DRAWINGS

FIG. 1 is a block diagram showing an example of the arrangement of a photoelectric conversion apparatus including a signal processor;

FIG. 2 is a view for explaining a photoelectric conversion unit;

FIG. 3 is a block diagram of the signal processor;

FIG. 4 is a block diagram of a black level correction unit;

FIG. 5 is a view for explaining a signal level at the time of occurrence of horizontal smear;

FIG. 6 is a block diagram of a detection unit;

FIG. 7 is a block diagram of a correction value generation unit according to the first embodiment;

FIG. 8 is a view for explaining a signal level before black level correction;

FIG. 9 is a view for explaining a signal level after black level correction;

FIG. 10 is a flowchart showing a black level correction unit processing method according to the first embodiment;

FIG. 11 is a block diagram of a black level correction unit in a signal processor according to the second embodiment;

FIG. 12 is a block diagram of a correction value generation unit in the black level correction unit according to the second embodiment;

FIG. 13 is a flowchart showing a black level correction unit correction method according to the second embodiment;

FIG. 14 is a block diagram of a detection unit in a black level correction unit according to the third embodiment; and

FIG. 15 is a view showing an example of application of a signal processor to equipment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

Each embodiment described below will mainly exemplify an apparatus used for imaging (imaging apparatus) as an example of a photoelectric conversion apparatus. Each embodiment is not limited to the apparatus used for imaging and can be applied to other examples of the photoelectric conversion apparatus. The examples include a distance measuring apparatus (for example, an apparatus for distance measurement using focus detection or Time Of Flight (TOF)) and a photometric apparatus (for example, an apparatus for the measurement of the amount of incident light).

### First Embodiment

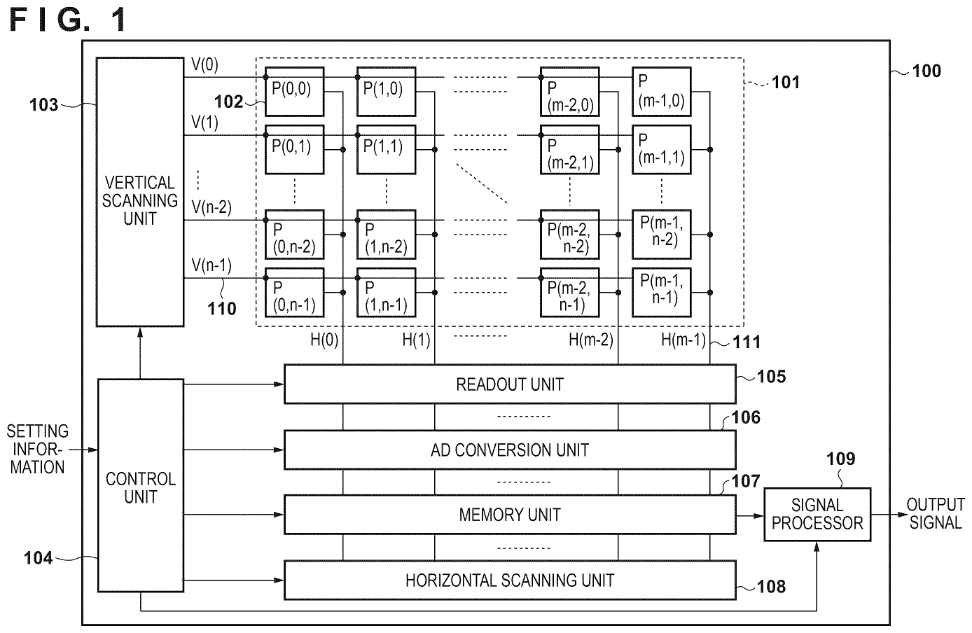

An example of the arrangement of a photoelectric conversion apparatus 100 including a signal processor 109 according to the present embodiment will be described with reference to FIG. 1. The photoelectric conversion apparatus 100 includes the signal processor 109 and a photoelectric conversion unit 101 that has a light receiving region and a light shielded region and outputs image data processed by the signal processor 109. The photoelectric conversion apparatus 100 can further include a vertical scanning unit 103, a control unit 104, a readout unit 105, an AD conversion unit 106, a memory unit 107, and a horizontal scanning unit 108. The present embodiment exemplifies the case in which the signal processor 109 is provided in the photoelectric conversion apparatus 100. However, limitation is not made thereto. The signal processor 109 may be separate from the photoelectric conversion apparatus 100.

The photoelectric conversion unit 101 has m×n pixels P(0,0) to P(m−1, n−1) arranged in a matrix pattern. Each pixel includes a photoelectric conversion element and generates electric charge corresponding to incident light. The vertical scanning unit 103 is connected to m pixels 102 arranged on rows by row selection lines 110 (n lines V(0) to V(n−1) in FIG. 1) and can select a row from which signals are to be read out. In normal times, the vertical scanning unit 103 selects rows from the 0th row to the (n−1)th row. Signals from the pixels on the rows selected by the vertical scanning unit 103 are read out to the readout unit 105 via vertical output lines 111 (m lines H(0) to H(m−1)). The readout unit 105 may include an amplifier to amplify a signal output from the pixel 102.

In the following description, a direction in which the row selection lines 110 extend will be referred to as the row direction (the horizontal direction in FIG. 1), and a direction in which the vertical output lines 111 extend will be referred to as the column direction (the vertical direction in FIG. 1).

Signals output from the readout unit 105 are converted from analog signals to digital signals (AD conversion) by the analog/digital (AD) conversion unit 106 and temporarily held in the memory unit 107. Thereafter, the digital signals address-designated by the horizontal scanning unit 108 are sequentially read out to the signal processor 109. The signal processor 109 then performs digital signal processing for the digital signals. The control unit 104 can acquire setting information such as imaging conditions at the time of imaging by the photoelectric conversion apparatus 100 and supply a control signal to each component of the photoelectric conversion apparatus 100 according to each configuration condition. The control unit 104 can control the vertical scanning unit 103, the readout unit 105, the AD conversion unit 106, the memory unit 107, the horizontal scanning unit 108, and the signal processor 109.

The signal processor 109 executes the processing of reducing reset noise generated in a switch element (for example, a MOS transistor) included in each pixel 102 of the photoelectric conversion unit 101. In addition, image data output from the photoelectric conversion unit 101 can include variation (fixed pattern noise (FPN)) caused by dark currents generated from the photodiodes included in the pixels 102 and differences in circuits, such as, power supply impedances and signal delays. Note that in this specification, a state in which this FPN changes for each row and each column will be referred to as shading.

The signal processor 109 generates correction data including an FPN component or shading component by averaging light shielded data for each row and each column after reducing a reset noise component. The signal processor 109 can then perform the processing of correcting variation for each column and the processing of correcting dark current components from pixels. The signal processor 109 can also perform black level correction.

The arrangement of the pixels of the photoelectric conversion unit 101 will be described with reference to FIG. 2. The pixels are arranged in a matrix pattern in the photoelectric conversion unit 101. The photoelectric conversion unit 101 includes a light receiving region 201 in which light receiving pixels that receive light entering an optical system such as a lens are arranged and a light shielded region 202 (which can also be called an optical black (OB) region) in which light shielded pixels that optically shield against incident light are arranged. Image data can be obtained from light receiving pixels in the light receiving region 201. Light shielded data can be obtained from light shielded pixels in the light shielded region 202. The light shielded region 202 is a reference region for determining a black level reference in data obtained by the photoelectric conversion unit 101.

The light shielded region 202 is divided into a vertical OB (VOB) region 203 and a horizontal OB (HOB) region 204. In the VOB region, the optically light shielded pixels 102 are arranged in the row direction throughout all the columns. In the horizontal OB region, the optically light shielded pixels 102 are arranged in the column direction throughout all the rows. The VOB region is located in an end portion of the photoelectric conversion unit 101 in the column direction. This region is the portion shown on the upper side in FIG. 2. The HOB region is located in an end portion of the photoelectric conversion unit 101 in the row direction. This region is the portion shown on the left side in FIG. 2.

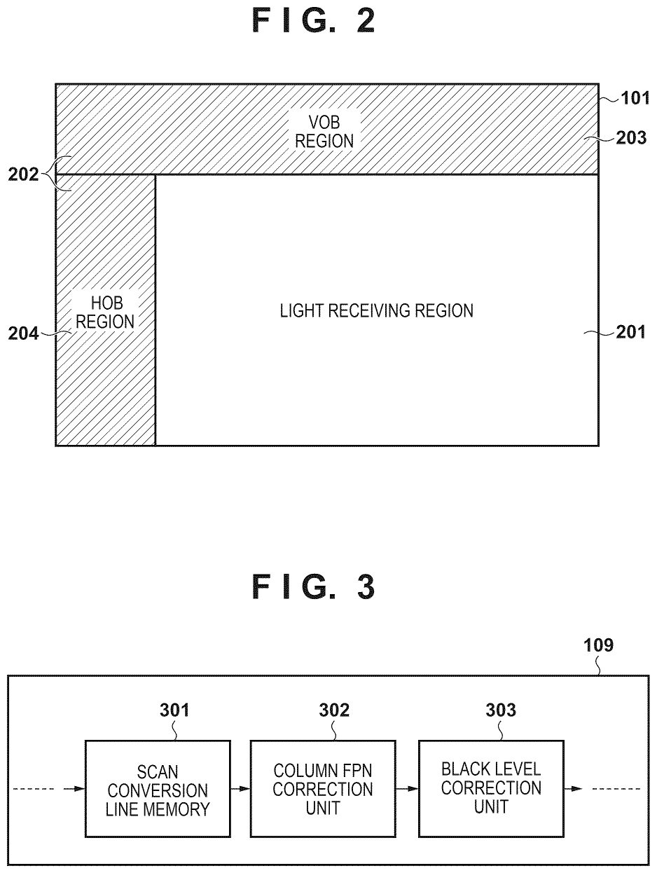

The signal processor 109 according to the present embodiment will be described with reference to FIG. 3. The signal processor 109 includes a scan conversion line memory 301, a column FPN correction unit 302, and a black level correction unit 303. The scan conversion line memory 301 is a storage unit that can hold at least one-row data of data input from the memory unit 107. The column FPN correction unit 302 is a circuit that corrects FPN for each column including shading in the horizontal direction.

The black level correction unit 303 corrects dark current components of pixels by using light shielded data from light shielded pixels. This processing is also called OB clamp processing. In this case, the processing will be referred to as black level correction. In this case, a region where light shielded data is acquired can be set to an arbitrary region in the light shielded region 202. In addition, a region where the average value of light shielded data is acquired for each row and each column can be set to an arbitrary region in the light shielded region 202. This region can be regarded as a region for the generation of a correction value for black level correction. Furthermore, a correction value that is calculated from light shielded data and used for black level correction can be called a clamp value.

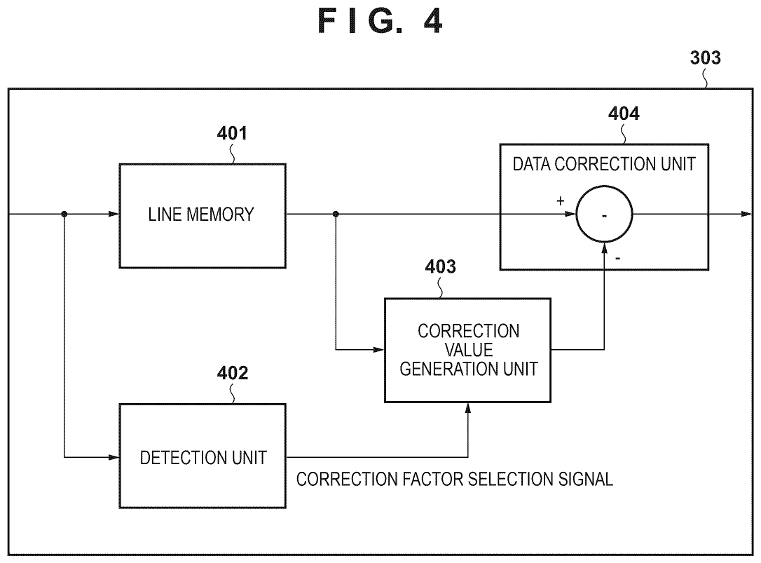

The arrangement of the black level correction unit 303 in the signal processor 109 according to the present embodiment will be described with reference to FIG. 4. The black level correction unit 303 can include a line memory 401, a detection unit 402, a correction value generation unit 403, and a data correction unit 404. Image data and light shielded data from a row selected as a black level correction target are sequentially input to the black level correction unit 303. The image data and the light shielded data input to the black level correction unit 303 are branched and input to the line memory 401 and the detection unit 402. The line memory 401 is a storage unit that can hold at least one-row data of the data of the selected row. The data of the selected row is input to the detection unit 402 to detect horizontal smear.

The detection unit 402 detects a phenomenon in which horizontal band-like brightening can occur from the data input to the black level correction unit 303 and generates a correction factor selection signal. For example, in a CMOS image sensor, there is known a phenomenon in which when strong light strikes the light receiving region 201, the signal levels in both the light receiving region 201 and the HOB region 204 reach the brightening level to cause a region different in brightness from other regions in a band-like pattern. This phenomenon is called horizontal smear.

The correction value generation unit 403 selects a correction factor based on the correction factor selection signal output from the detection unit 402 and generates a correction value for black level correction by using the light shielded data output from the line memory 401. The data correction unit 404 can perform black level correction for output data from the line memory 401 by subtracting the correction value generated by the correction value generation unit 403 from the output data from the line memory 401.

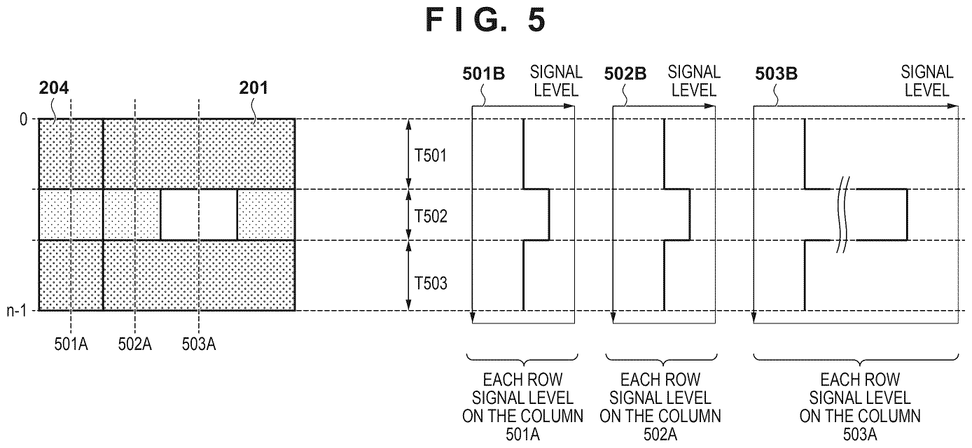

Horizontal smear will be further described with reference to FIG. 5. FIG. 5 shows images of the light receiving region 201 and the HOB region 204 in the presence of horizontal smear caused by strong light striking a middle portion of the frame (an open portion in FIG. 5) and signal levels of pixels on the respective rows at the positions of columns 501A, 502A, and 503A shown in the images. The column 501A indicates the position of a column in the HOB region 204. The column 502A indicates the position of a column in the light receiving region 201 which is not struck by strong light. The column 503A indicates the position of a column in the light receiving region 201 which is struck by strong light.

A signal level 501B indicates each row signal level on the column 501A in the HOB region 204. A signal level 502B indicates each row signal level on the column 502A in the light receiving region 201 which is not struck by strong light. A signal level 503B indicates each row signal level on the column 503A in the light receiving region 201 which is struck by strong light.

On the right and left sides of the portion in the middle of the frame which is struck by strong light, not only the signal level on the column 503A but also the signal levels on the columns 501A and 502A reach the brightening level, and hence a horizontal band-like bright region can occur on the row indicated by T502. This corresponds to the position where the signal levels 501B, 502B, and 503B horizontally increase in a convex form in FIG. 5. Such a horizontal band will be referred to as horizontal smear.

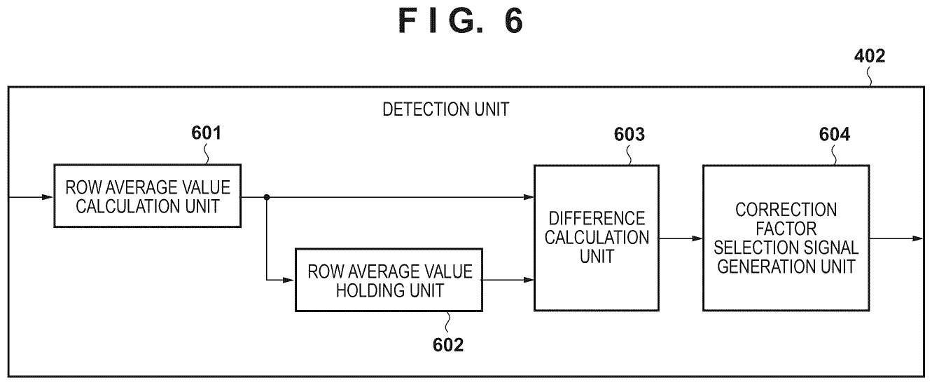

The detection unit 402 of the signal processor 109 according to the present embodiment will be described with reference to FIG. 6. The detection unit 402 includes a row average value calculation unit 601, a row average value holding unit 602, a difference calculation unit 603, and a correction factor selection signal generation unit 604. The detection unit 402 can generate a correction factor selection signal by detecting horizontal smear.

The row average value calculation unit 601 calculates and outputs the average value of pixel data on a row targeted to black level correction. The row selected as a black level correction target is the same row as the data held in the line memory 401. The row average value holding unit 602 holds an output from the row average value calculation unit 601. The row average value calculation unit 601 calculates the average of data from light receiving pixels on the row in the light receiving region 201 which is selected as the black level correction target. An average value may be calculated by using data from pixels in both the light receiving region 201 and the light shielded region 202.

The difference calculation unit 603 calculates the difference between the average value of the data calculated by the row average value calculation unit 601 and the average value of the pixel data on a predetermined row which is held in the row average value holding unit 602. Calculating the difference can detect the change caused by horizontal smear. The detection unit 402 can detect horizontal smear based on a sufficient number of data by using the data of light receiving pixels in the light receiving region.

In this case, a predetermined row is a row serving as a reference for the detection of horizontal smear. If a row targeted to black level correction is the Nth row, the average value of the pixel data on the Mth row (M≠N, M≥0) may be calculated. In this case, the Mth row may be the (N−1)th row. If M=N−1, a change in data due to horizontal smear can be detected by comparing the values on adjacent rows. In addition, whether to use data from the light receiving region or data from the light receiving region and the light shielded region as data to be held by the row average value holding unit 602 can be selected in accordance with the operation of the row average value calculation unit 601.

The correction factor selection signal generation unit 604 generates and outputs a correction factor selection signal upon comparing the difference calculated by the difference calculation unit 603 with a detection level threshold. If the difference is equal to or larger than the detection level threshold, the correction factor selection signal generation unit 604 generates and outputs a correction factor selection signal that selects a correction factor exhibiting high tracking performance of black level correction. If the difference is smaller than the detection level threshold, the correction factor selection signal generation unit 604 generates and outputs a correction factor selection signal that selects a correction factor exhibiting low tracking performance of black level correction. Referring to FIG. 5, since the difference can increase at a boundary portion between the row indicated by T501 and the row indicated by T502 or a boundary portion between the row indicated by T502 and the row indicated by T503, the tracking performance of black level correction can be increased.

If the correction factor selection signal changes, the correction factor selection signal generation unit 604 can stop generating a correction factor selection signal over a plurality of rows. If the difference changes to a value larger than the detection level threshold, the same correction factor selection signal may be applied over a predetermined number of rows including the row as a correction target and subsequent rows. The tracking performance of correction is increased with respect to rows around a portion where horizontal smear has occurred, including a correction target row, instead of generating and outputting a correction factor selection signal for selecting a correction factor exhibiting high tracking performance of black level correction with respect to only the target row. This makes it possible to properly perform correction around the portion where horizontal smear has occurred.

The data correction unit 404 performs black level correction for the data on the row held in the line memory 401 based on the correction value generated by the correction value generation unit 403. In the above manner, black level correction for the data on the row held in the line memory 401 is performed by using the correction value generated based on the data on the same row as that held in the line memory. The control unit 104 performs a series of operations including holding and reading with respect to the line memory 401, detecting by the detection unit 402, and generating and correcting of a correction value by controlling the timing.

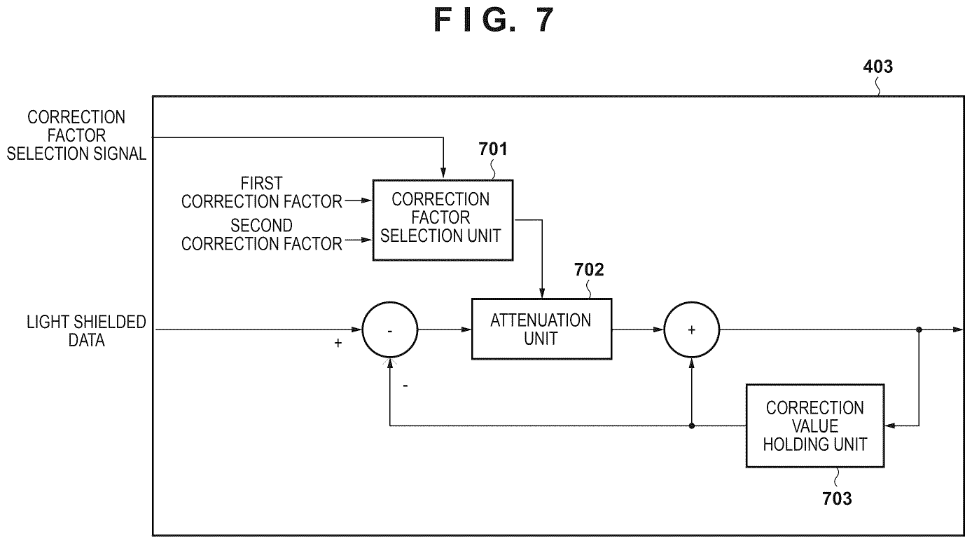

The correction value generation unit 403 in the signal processor 109 according to the present embodiment will be described with reference to FIG. 7. The correction value generation unit 403 includes a correction factor selection unit 701, an attenuation unit 702, and a correction value holding unit 703. The correction value generation unit 403 generates and updates a correction value by filter processing. The correction value held in the correction value holding unit 703 is subtracted from the light shielded data of a light shielded pixel. The attenuation unit 702 then attenuates the subtraction result by using the correction factor selected by the correction factor selection unit 701. Finally, the correction value generation unit 403 generates a new correction value by adding the attenuation result to the correction value held in the correction value holding unit 703 and holds it in the correction value holding unit 703. Sequentially performing this operation for light shielded pixels on the rows selected as black level correction targets can obtain a correction value based on a light shielded pixel in VOB on the same row as that held in the line memory 401.

In performing filter processing, the correction value generation unit 403 according to the present embodiment can use a type of filter that smooths input data, such as low pass filter. Filter processing according to the present embodiment is performed by inputting light shielded data to the filter for each pixel and filtering the data. The filter can be implemented by a low pass filter (LPF) of an infinite impulse response (IIR) type. In this case, the correction factor corresponds to an attenuation factor K used for the multiplication of the IIR filter. Note that the arrangement of the filter is not limited to this as long as the response characteristic of the filter can be changed.

The correction factor selection unit 701 selects the first correction factor or the second correction factor based on a correction factor selection signal. This specification exemplifies a case where the first correction factor is selected when the correction factor selection signal is 0, and the second correction factor is selected when the correction factor selection signal is 1.

If, for example, the second correction factor is a correction factor exhibiting higher tracking performance of an IIR-type LPF than the first correction factor, a correction value is generated by using the first correction factor in normal times, and a correction value is generated by using the second correction factor at the time of detection of horizontal smear. Selecting the second correction factor exhibiting high tracking performance at the time of detection of horizontal smear can follow up steep variation in black level due to the occurrence of horizontal smear and effectively correct the horizontal smear.

The attenuation unit 702 sets the attenuation amount of the IIR-type LPF by using the correction factor selected by the correction factor selection unit 701. Accordingly, the correction factor corresponds to the attenuation factor set by the IIR-type filter. As the attenuation factor increases, the response characteristic of the filter increases, thus properly performing correction at an edge portion exhibiting a large change in horizontal smear.

Note that the present embodiment has exemplified the case where there are two correction factors to be selected by the correction factor selection unit 701. However, the number of correction factors is not specifically limited. In addition, although the present embodiment has exemplified the case where the correction factor selection unit 701 switches between the correction factors based on a correction factor selection signal, the control unit 104 can also control the signal processor so as not to switch between the correction factors in accordance with an imaging condition or the type of imaging apparatus.

The following equation indicates the value of a correction value Y using the IIR filter shown in FIG. 7. In this case, Y_₁ is the correction value held in the correction value holding unit 703, K is an attenuation factor, and X is light shielded data.

$$Y = K \times Y + ( 1 - K ) \times {Y}_{\_ 1} \qquad ( 1 )$$

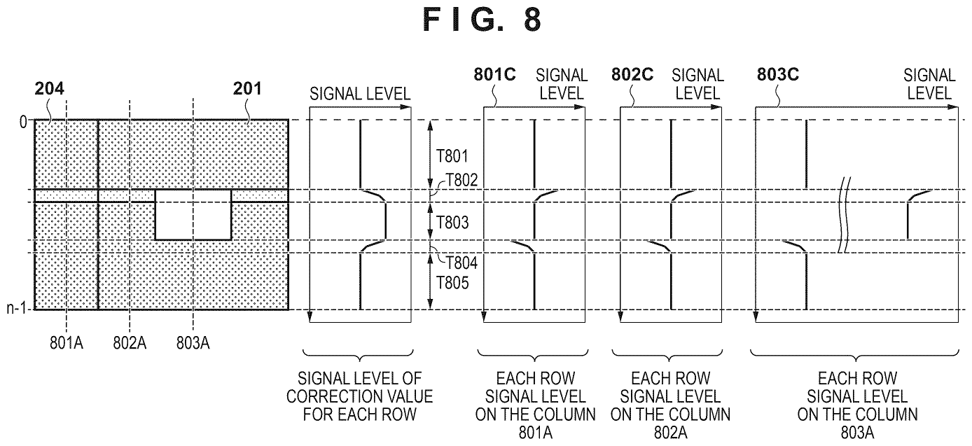

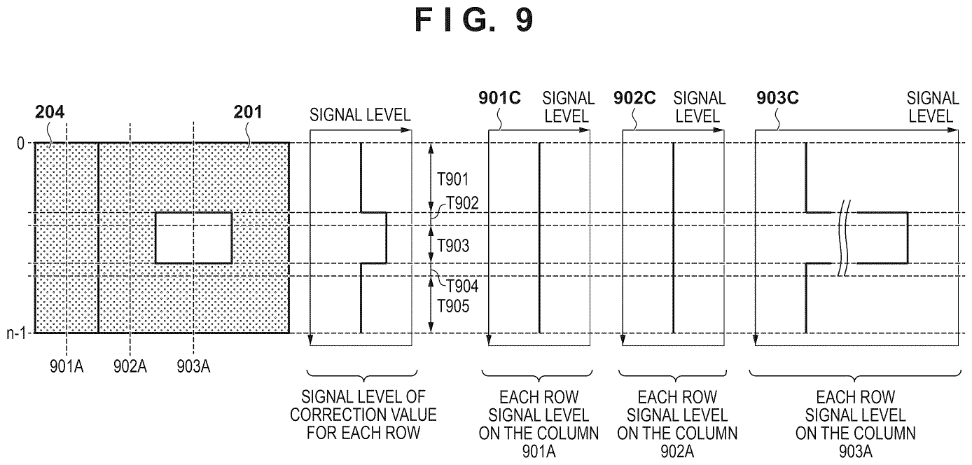

An image having undergone black level correction according to a comparative example and an image having undergone black level correction according to the present embodiment will be comparatively described with reference to FIGS. 8 and 9. The input data of the black level correction unit 303 remains the same in FIGS. 8 and 9. Assume that the black level correction in the comparative example in FIG. 8 is processing exhibiting low tracking performance of filter processing. Assume also that the black level correction according to the present embodiment shown in FIG. 9 is processing exhibiting high tracking performance of filter processing only for a few rows after the detection of horizontal smear and low tracking performance of filter processing for the remaining rows.

The comparative example of black level correction will be described first with reference to FIG. 8. FIG. 8 shows images of the light receiving region 201 and the HOB region 204, the signal level of a correction value, and signal levels 801C, 802C, and 803C of image signals having undergone black level correction at the positions of columns 801A, 802A, and 803A in the image when horizontal smear has been caused by strong light (the hollow portion in FIG. 8) in the middle of the frame.

Since no horizontal smear has occurred on the row indicated by T801, even if the correction value changes, the change width is small. Accordingly, even if the tracking performance of filter processing is low, a change in signal level is small, and a good correction result is obtained.

The row indicated by T802 is a region immediately after the start of horizontal smear. The signal level at the column 801A is high due to the influence of horizontal smear. Since the tracking performance of filter processing is low, the signal level of the correction value increases only gradually. For this reason, it takes time for the effect of the correction to show up. According to the comparative example, since black level correction is performed based on the correction factor exhibiting low tracking performance, as indicated by the signal level 801C at the position of the column 801A, brightening is conspicuous at the upper portion of the row indicated by T802, and the effect of the correction shows up more along the lower portion, thus showing how brightening is reduced.

Although horizontal smear has occurred on the row indicated by T803, the change width of the correction value is small. For this reason, even if the tracking performance of filter processing is low, a good correction result can be obtained. The row indicated by T804 is a region immediately after the end of horizontal smear. Since the tracking performance of filter processing is low, the correction value changes only gradually. Accordingly, as a result of black level correction, as indicated by the signal level 801C at the position of the column 801A, darkening is conspicuous at the upper portion of the row indicated by T804, and the darkening is reduced more along the lower portion.

Since no horizontal smear has occurred on the row indicated by T805, the change width of the correction value is small. For this reason, even if the tracking performance of filter processing is low, a good correction effect can be obtained. As described above, after black level correction according to the comparative example, correction residues occur in a region immediately after the start of horizontal smear and a region immediately after the end of the horizontal smear, and the images of the upper and lower portions of the horizontal smear are emphasized by the correction in a band-like pattern.

Black level correction according to the present embodiment will be described next with reference to FIG. 9. FIG. 9 shows images of the light receiving region 201 and the HOB region 204, the signal level of a correction value on each row, and signal levels 901C, 902C, and 903C on each row at columns 901A, 902A, and 903A after black level correction according to the present embodiment when horizontal smear has been caused by strong light entering the middle of the frame.

Since no horizontal smear has occurred on the row indicated by T901, the change width of the correction value is small. For this reason, the tracking performance of filter processing is reduced in order to prevent the correction value from being easily influenced by random noise in the HOB region 204.

The row indicated by T902 is a region immediately after the start of horizontal smear. Although the signal level 903C indicated at the column 903A is high, the detection unit 402 detects a change in the signal level in black level correction according to the present embodiment, and a correction factor is selected so as to increase the tracking performance of filter processing. As a result, as shown in FIG. 9, the signal level of the correction value instantaneously becomes high, and a good correction result is obtained from the upper portion of the row indicated by T902.

Although horizontal smear has occurred on the row indicated by T903, a change in luminance is small within this range, and the change width of the correction value is small. For this reason, it is possible to prevent the correction value from being easily influenced by random noise in the HOB region 204 by reducing the tracking performance of filter processing. That is, in this period, the detection unit 402 can select a correction factor selected so as to reduce the tracking performance.

The row indicated by T904 is a region immediately after the end of horizontal smear. Although the signal level at the column 901A is low, the detection unit 402 detects a change in the signal level in black level correction according to the present embodiment and selects a correction factor so as to increase the tracking performance of filter processing. As a result, since the correction value can be reduced in a short period of time, a good correction result is obtained from the upper portion of the row indicated by T902.

Since no horizontal smear has occurred at T905, a change in luminance is small, and the change width of the correction value is small. For this reason, the tracking performance of filter processing is reduced in order to prevent the correction value from being easily influenced by random noise in the HOB region 204.

As described above, in black level correction according to the present embodiment, since the tracking performance of correction is increased in a region immediately after the start of horizontal smear and a region immediately after the end of the horizontal smear, the correction indicated by FIG. 9 can suppress the emphasis of correction residues as compared with the correction indicated in FIG. 8.

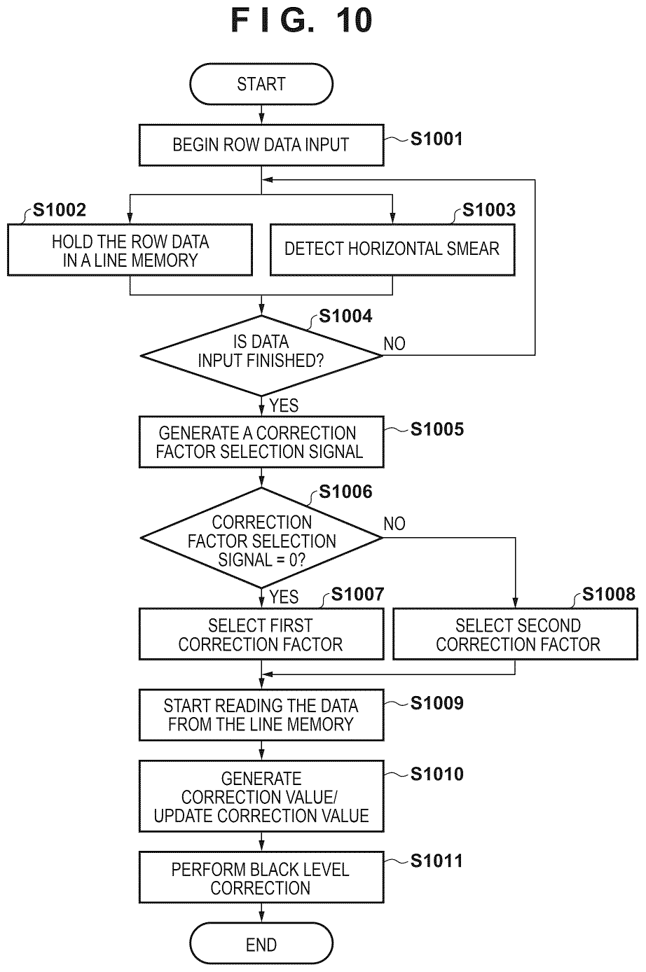

Signal processing by the black level correction unit 303 in the signal processor 109 according to the present embodiment will be described with reference to the flowchart of FIG. 10. The black level correction unit 303 corrects horizontal smear in steps S1001 to S1011 shown in FIG. 10.

In step S1001, the black level correction unit 303 inputs the data on the row selected as a target for black level correction to the line memory 401 and the detection unit 402. The data on the selected row can be branched and input to the line memory 401 and the detection unit 402. In step S1002, the row data is held in the line memory 401.

In step S1003, the black level correction unit 303 refers to the data on the row input to the detection unit 402 and detects horizontal smear. In step S1004, the black level correction unit 303 determines whether the inputting of row data corresponding to one row is completed. If the inputting is completed (Yes in step S1004), the process shifts to step S1005 to cause the correction factor selection signal generation unit 604 to generate a correction factor selection signal. If the inputting is not completed (No in step S1004), the process returns to the step of inputting the row data.

In step S1005, if no horizontal smear is detected, a correction factor selection signal is generated as 0, whereas if horizontal smear is detected, a correction factor selection signal is generated as 1. In step S1006, the black level correction unit 303 determines whether the correction factor selection signal is 0. If correction factor selection signal=0 (Yes in step S1006), the process shifts to step S1007 to select the first correction factor. If correction factor selection signal≠0 (No in step S1006), the process shifts to step S1008 to select the second correction factor.

In step S1009, the black level correction unit 303 starts to read out the data on the selected row held in the line memory. In step S1010, the black level correction unit 303 updates/generates the correction value by causing the correction value generation unit 403 to perform filter processing for data for each pixel by using light shielded data for each pixel. In step S1011, the black level correction unit 303 performs black level correction concerning the data on the selected row by using the updated correction value.

Repeating the above operation for each row makes it possible to suppress the occurrence of horizontal stripes by performing correction exhibiting low tracking performance in normal times and correct horizontal smear by performing correction exhibiting high tracking performance at the time of detection of the horizontal smear.

### Second Embodiment

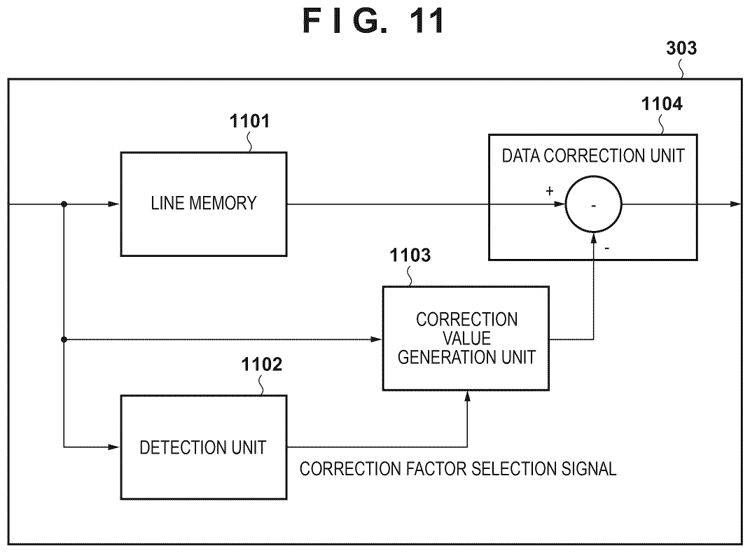

A signal processor according to the present embodiment will be described with reference to FIGS. 11 to 13. The present embodiment differs from the first embodiment in the relationship between the flows of data inside a black level correction unit and the arrangement of the correction value generation unit. Other arrangements are similar to those in the first embodiment, and a description thereof will sometimes be omitted.

A black level correction unit 303 in a signal processor 109 according to the present embodiment will be described with reference to the block diagram shown in FIG. 11. The black level correction unit 303 includes a line memory 1101, a detection unit 1102, a correction value generation unit 1103, and a data correction unit 1104.

The line memory 1101 is a storage unit that holds at least one-line data of the data input to the black level correction unit 303. The light shielded data in the HOB region 204 need not always be held in the line memory 1101, and only the image data in a light receiving region 201 may be held in the line memory 1101.

The detection unit 1102 detects a phenomenon in which horizontal stripes can occur from the data input to the black level correction unit 303 and generates a correction factor selection signal.

The correction value generation unit 1103 selects a correction factor based on the correction factor selection signal output from the detection unit 1102 and generates a correction value by using the light shielded data input to the black level correction unit 303.

The data correction unit 1104 subtracts the correction value output from the correction value generation unit 1103 from the output data from the line memory 1101.

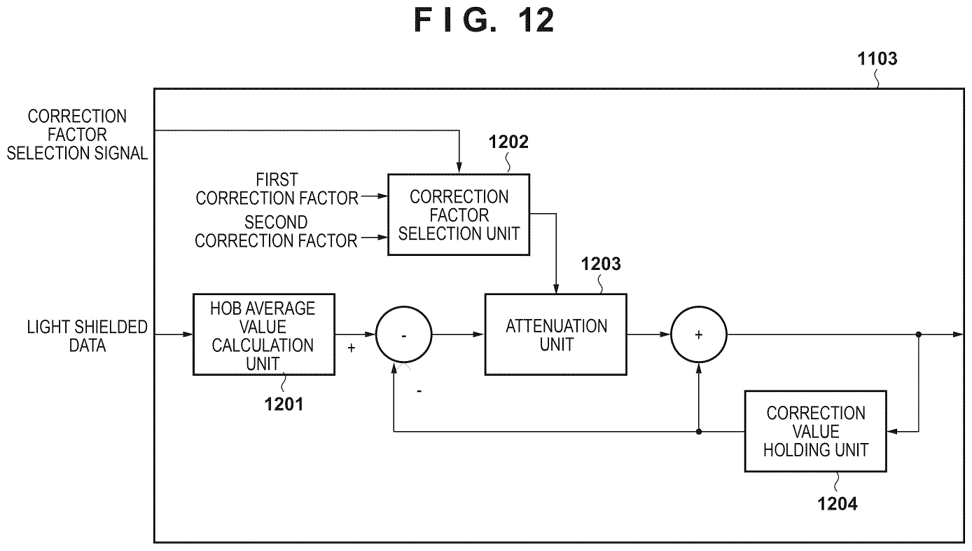

The correction value generation unit 1103 in the signal processor 109 according to the present embodiment will be described with reference to the block diagram shown in FIG. 12. The correction value generation unit 1103 includes an HOB average value calculation unit 1201, a correction factor selection unit 1202, an attenuation unit 1203, and a correction value holding unit 1204.

The correction value generation unit 1103 updates the correction value by filter processing. First of all, the HOB average value calculation unit 1201 calculates the average value of the light shielded data of the row selected as a correction target. The correction value held in the correction value holding unit 1204 is subtracted from the calculated average value. The attenuation unit 1203 attenuates the subtraction result by using the correction factor selected by the correction factor selection unit 1202. Finally, a new correction value is generated by adding the attenuation result and the correction value held in the correction value holding unit 1204 and is held in the correction value holding unit 1204.

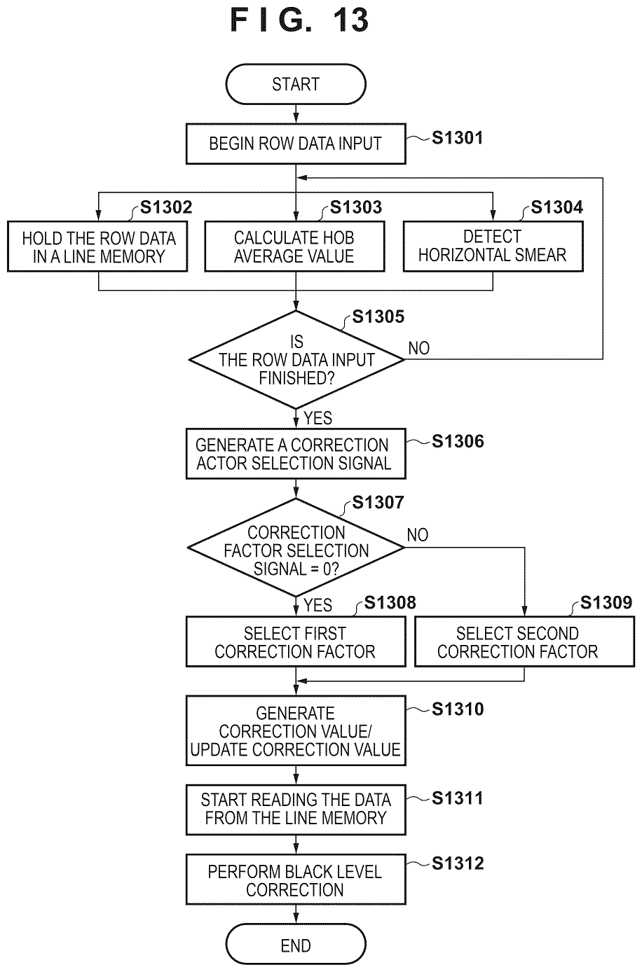

Signal processing by the black level correction unit 303 in the signal processor 109 according to the present embodiment will be described with reference to the flowchart shown in FIG. 13. The black level correction unit 303 corrects horizontal smear in steps S1301 to S1312 in FIG. 13.

First of all, in step S1301, row data is branched to the line memory 1101 and the detection unit 1102. At this time, the light shielded data on the selected row is input to the correction value generation unit 1103. In step S1302, the row data is held in the line memory 1101. In step S1303, the HOB average value calculation unit calculates the average value of the light shielded data.

In step S1304, the correction value generation unit 1103 refers to the row data input to the detection unit 1102 and detects horizontal smear. In step S1305, the correction value generation unit 1103 determines whether the inputting of the row data corresponding to one row is completed. If the inputting is completed (Yes in step S1305), the process shifts to step S1306 to cause the correction factor selection signal generation unit 604 to generate a correction factor selection signal. If the inputting is not completed (No in step S1305), the process returns to the step of inputting row data.

In step S1306, a correction factor selection signal is generated as 0 if no horizontal smear is detected, whereas a correction factor selection signal is generated as 1 if horizontal smear is detected. In step S1307, the correction value generation unit 1103 determines whether the correction factor selection signal is 0. If correction factor selection signal=0 (Yes in step S1307), the process shifts to step S1308 to select the first correction factor. If correction factor selection signal≠0 (No in step S1307), the process shifts to step S1309 to select the second correction factor.

In step S1310, the correction value generation unit 1103 performs filter processing to update the correction value. In step S1311, the correction value generation unit 1103 starts to read out the row data held in the line memory. In step S1312, the correction value generation unit 1103 performs black level correction using the updated correction value.

Repeating the above operation makes it possible to suppress the occurrence of horizontal stripes by performing correction exhibiting low tracking performance in normal times and correct horizontal smear by performing correction exhibiting high tracking performance at the time of detection of the horizontal smear.

According to the first embodiment, since the correction value is updated for each pixel, the influence of the light shielded data on each row to the correction value differs between the light shielded data head column and the light shielded data last column. However, according to the second embodiment, since the correction value is updated by using an HOB average value, the influence of the light shielded on each column to the correction value remains the same.

### Third Embodiment

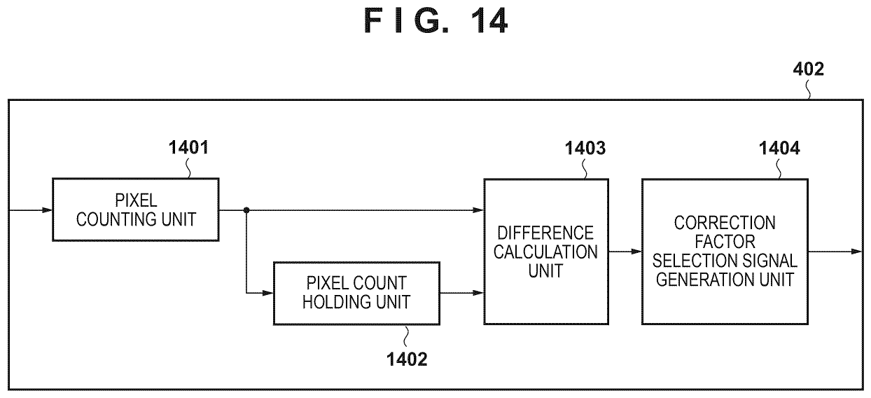

A signal processor according to the present embodiment will be described with reference to FIG. 14. The present embodiment differs from the second embodiment in the arrangement of a detection unit. Other arrangements are similar to those in the first and second embodiments, and a description thereof will be omitted.

A detection unit 402 in a signal processor 109 according to the present embodiment will be described with reference to the block diagram shown in FIG. 14. The detection unit 402 includes a pixel counting unit 1401, a pixel count holding unit 1402, a difference calculation unit 1403, and a correction factor selection signal generation unit 1404. The pixel counting unit 1401 counts the number of pixels exceeding a predetermined threshold level among the data from the light receiving pixels on the Nth (N≥0) row.

The pixel count holding unit 1402 holds an output from the pixel counting unit 1401. The difference calculation unit 1403 calculates the difference between the number of pixels that has a level exceeding the threshold level on the Nth row held in the pixel count holding unit 1402 and the number of pixels that has a level exceeding the threshold level on the Mth (M≠N, M≥0) row calculated by the pixel counting unit.

The correction factor selection signal generation unit 1404 generates a correction factor selection signal by comparing the difference calculated by the difference calculation unit 1403 with a designated detection level threshold. If, for example, the difference is larger than the detection level threshold, a correction factor selection signal that increases the tracking performance of black level correction is generated. If the difference is smaller than the detection level threshold, a correction factor selection signal that decreases the tracking performance of black level correction is generated.

In addition, if the correction factor selection signal changes, the correction factor selection signal generation unit 1404 can stop updating the correction factor selection signal for a predetermined period over a plurality of rows. If, for example, the difference is larger than the detection level threshold, the correction factor is changed over a predetermined number of rows including the corresponding row instead of being changed from the correction factor in normal times on only the corresponding row.

In the first embodiment, a correction factor selection signal is generated from the difference between the average value on the Nth row and the average value on the Mth row. Accordingly, when an object that greatly increases the average value is imaged, the horizontal smear detection accuracy tends to be influenced by the luminance of an object pattern. In contrast to this, in the third embodiment, a correction factor selection signal is generated from the difference between the number of pixels having signal levels exceeding a predetermined threshold level on the Nth row and the number of pixels having signal levels exceeding a threshold level on the Mth row. This prevents the horizontal smear detection accuracy from being easily influenced by an object pattern.

### <Application of Signal Processor to Equipment>

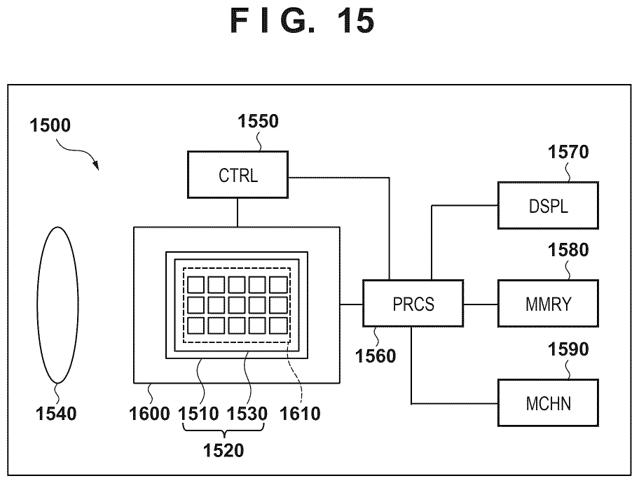

The following is a description of equipment 1500 that includes a semiconductor apparatus 1600 including a package 1520 on which a semiconductor chip 1610 including a signal processor according to the present embodiment is mounted, as shown in FIG. 15. The semiconductor chip 1610 is accommodated in the package 1520 and mounted on the equipment 1500. In the arrangement shown in FIG. 15, the semiconductor chip 1610 includes the signal processor according to the embodiment described above. The semiconductor apparatus 1600 can include the package 1520 including a base 1510 on which the semiconductor chip 1610 is fixed and a light transmissive member 1530 such as glass when the semiconductor chip 1610 includes an image sensor. The package 1520 can be provided with joining members such as wires and bumps that connect inner leads provided on the base 1510 to terminals such as pad electrodes provided on the semiconductor chip 1610.

The equipment 1500 can include at least one of an optical apparatus 1540, a control apparatus 1550, a processing apparatus 1560, a display apparatus 1570, a storage apparatus 1580, and a mechanical apparatus 1590. The optical apparatus 1540 is implemented by, for example, a lens, a shutter, and a mirror. The control apparatus 1550 controls the semiconductor chip 1610. The control apparatus 1550 is, for example, a semiconductor device such as an ASIC.

The processing apparatus 1560 processes a signal output from the semiconductor integrated circuit included in the semiconductor chip 1610. The processing apparatus 1560 is a semiconductor device such as a CPU or an ASIC for forming an analog front end AFE or a digital front end DFE. For example, when the semiconductor chip includes an image sensor, an image may be generated based on event signals E. The display apparatus 1570 is an EL display device or a liquid crystal display device that displays an information image obtained by the semiconductor chip 1610. The storage apparatus 1580 is a magnetic device or a semiconductor device that stores the information image obtained by the semiconductor chip 1610. The storage apparatus 1580 is a volatile memory such as an SRAM or a DRAM, or a nonvolatile memory such as a flash memory or a hard disk drive.

The mechanical apparatus 1590 includes a moving or propulsion unit such as a motor or an engine. In the equipment 1500, the signal output from the semiconductor chip 1610 is displayed on the display apparatus 1570 or transmitted to an external apparatus by a communication apparatus (not shown) included in the equipment 1500. Hence, the equipment 1500 may further include the storage apparatus 1580 and the processing apparatus 1560 in addition to the memory circuits and arithmetic circuits included in the semiconductor chip 1610. The mechanical apparatus 1590 may be controlled based on the signal output from the semiconductor chip 1610.

In addition, the equipment 1500 is suitable for an electronic apparatus such as an information terminal (for example, a smartphone or a wearable terminal) which has a shooting function or a camera (for example, an interchangeable lens camera, a compact camera, a video camera, or a monitoring camera). The mechanical apparatus 1590 in the camera can drive the components of the optical apparatus 1540 in order to perform zooming, an in-focus operation, and a shutter operation. Alternatively, the mechanical apparatus 1590 in the camera can move the optical apparatus 1540 in order to perform an anti-vibration operation.

Furthermore, the equipment 1500 can be a transportation equipment such as a vehicle, a ship, or an airplane. The mechanical apparatus 1590 in the transportation equipment can be used as a moving apparatus. The equipment 1500 as the transportation equipment is suitable for an apparatus that transports the semiconductor chip 1610 or an apparatus that uses a shooting function to assist and/or automate drive steering. The processing apparatus 1560 for assisting and/or automating drive steering can perform, based on the information obtained by the semiconductor chip 1610, processing for operating the mechanical apparatus 1590 as a moving apparatus. Alternatively, the equipment 1500 may be medical equipment such as an endoscope, measurement equipment such as a distance measurement sensor, analysis equipment such as an electron microscope, office equipment such as a copy machine, or industrial equipment such as a robot.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-071637, filed Apr. 25, 2024, which is hereby incorporated by reference wherein in its entirety.

What is claimed is:

1. A signal processor that corrects image data based on signals from a plurality of light receiving pixels by using light shielded data based on signals from a plurality of light shielded pixels, comprising a line memory, a detection unit, a correction value generation unit, and a data correction unit,
wherein
the line memory holds image data on a selected row,
the detection unit generates a selection signal that selects a correction factor based on the image data on at least the selected row,
the correction value generation unit includes a correction value holding unit configured to hold a correction value and generates and holds the correction value based on the correction factor selected by the selection signal and light shielded data on the selected row, and
the data correction unit corrects image data on the selected row held in the line memory based on the correction value.

2. The processor according to claim 1, wherein the correction value generation unit updates the held correction value based on the correction factor selected by the selection signal and the light shielded data on the selected row.

3. The processor according to claim 1, wherein the image data and the light shielded data are branched and input to the line memory and the detection unit.

4. The processor according to claim 1, wherein the detection unit generates the selection signal based on comparison between an average value of image data of light receiving pixels on the selected row and an average value of pixel data of light receiving pixels on a row different from the selected row.

5. The processor according to claim 1, wherein the detection unit generates the selection signal based on comparison between the number of image data, of image data of light receiving pixels on the selected row, which exceeds a predetermined threshold and the number of image data, of image data of light receiving pixels on a row different from the selected row, which exceeds the predetermined threshold.

6. The processor according to claim 1, wherein the correction value generation unit includes a filter, and the correction factor includes an attenuation factor of the filter.

7. The processor according to claim 6, wherein the filter is an infinite impulse response filter.

8. The processor according to claim 6, wherein the correction value is generated based on filtering of light shielded data from each of the plurality of light shielded pixels on the selected row for each pixel by using the filter.

9. The processor according to claim 6, wherein the correction value is generated based on filtering of an average value of light shielded data from the plurality of light shielded pixels on the selected row by using the filter.

10. The processor according to claim 1, wherein the data correction unit corrects image data on a predetermined number of rows including the selected row based on the correction value.

11. The processor according to claim 1, wherein the line memory further holds light shielded data on the selected row, and
the data correction unit corrects light shielded data on the selected row held in the line memory based on the correction value.

12. A photoelectric conversion apparatus comprising:
a photoelectric conversion unit including a plurality of light receiving pixels and a plurality of light shielded pixels arranged in a matrix pattern, the plurality of light receiving pixels and the plurality of light shielded pixels including photoelectric conversion elements; and
a signal processor defined in claim 1.

13. Equipment comprising:
a signal processor defined in claim 1; and
a processing unit configured to process a signal output from the signal processor.
